(19) United States
(12) Patent Application Publication
(10) Pub. No.: US 2014/0022066 A1
(43) Pub. Date: Jan. 23, 2014

(54) Theft Detection Apparatus

(71) Applicant: Luminescent Alarms Limited, Brampton Bierlow (GB)

(72) Inventor: David Richardson, Brampton Bierlow (GB)

(21) Appl. No.: 13/945,059

(22) Filed: Jul. 18, 2013

(30) Foreign Application Priority Data
Jul. 20, 2012 (GB) 1213001.9

(51) Int. Cl. B60R 25/01; B60R 25/102; B60R 25/33; B60R 25/40

(52) U.S. Cl. CPC B60R 25/01; B60R 25/40; B60R 25/102; B60R 25/33
USPC 340/426.17; 340/426.23; 340/426.2

(57) ABSTRACT

A license plate (401) is shown configured to be attached to a vehicle such that when so attached the license plate appears substantially similar to a conventional license plate. The license plate includes a concealed housing (403). Inside the housing, there is provided a position detection device (404) and a communication device (405). A battery 406 may also be provided within the housing 403 concealed battery 406 may be recharged from a battery present within the vehicle or it may receive electrical power from a photo-voltaic source 407.

### CROSS REFERENCE TO RELATED APPLICATIONS

This application claims priority from United Kingdom Patent Application number 1213001.9 filed Jul. 20, 2012, the entire disclosure of which is incorporated herein by reference in its entirety.

### BACKGROUND OF THE INVENTION

1. Field of the Invention

The present invention relates to a theft detection apparatus for a motor vehicle and an illumination device concealed within a visible component of the motor vehicle.

2. Description of the Related Art

Many theft detection devices are known that may cause an audible alarm to sound if, for example, a thief breaks into a motor vehicle. In some situations, it may be possible to disarm an alarm of this type and, unfortunately, it is also known for these types of alarms to be ignored. A more subtle problem exists in that if a thief is aware of the fact that an alarm can be raised, the thief may take action in order to suppress it. A problem therefore exists in terms of providing an alarm apparatus that is not immediately apparent to a thief.

### BRIEF SUMMARY OF THE INVENTION

According to a first aspect of the present invention, there is provided a thief detection apparatus for a motor vehicle. The apparatus comprises a license plate configured to be attached to a vehicle such that when so attached the license plate appears substantially similar to a conventional license plate. The license plate includes a concealed housing and inside this housing there is provided a position detection device and a communication device. In an embodiment, the vehicle also includes a first battery for supplying electrical energy to electrical components within the motor vehicle and electrical energy for the position detection device and the communication device may be received from this battery.

According to a second aspect of the invention, there is provided a theft detection apparatus for a motor vehicle. The apparatus comprises an illumination device concealed within a visible component of the motor vehicle, along with a geographical detection device concealed within the vehicle that has a programmable component. An interface is provided for programming the programmable component with details of a geo-fence, so as to produce an alarm signal in response to detecting that the vehicle has moved outside the geo-fence. An energising device is provided for activating the illumination device in response to receiving an alarm signal.

In an embodiment, the visible component may be a license plate.

According to a third aspect of the invention, there is provided an illuminating apparatus for a motor vehicle license plate. The apparatus comprises a base plate and a plastics material cover having a front portion, a first side portion and a second side portion. A first reflective edge plate is attached to the first side portion and a second reflective edge plate is attached to the second side portion. A first illuminating device is located behind the base plate so as to direct light into said first side portion.

In an embodiment, a second illuminating device is located behind the base plate so as to direct light into the second side portion.

### BRIEF DESCRIPTION OF THE DRAWINGS

FIG. 1 shows an attempted theft of a motor vehicle;

FIG. 2 shows an alarm activation operation;

FIG. 3 shows a license plate displaying a message;

FIG. 4 shows a schematic representation of a first theft detection apparatus;

FIG. 5 shows a schematic representation of a second theft detection apparatus; and

FIG. 6 shows an illuminating device.

### DETAILED DESCRIPTION OF EXAMPLE EMBODIMENTS

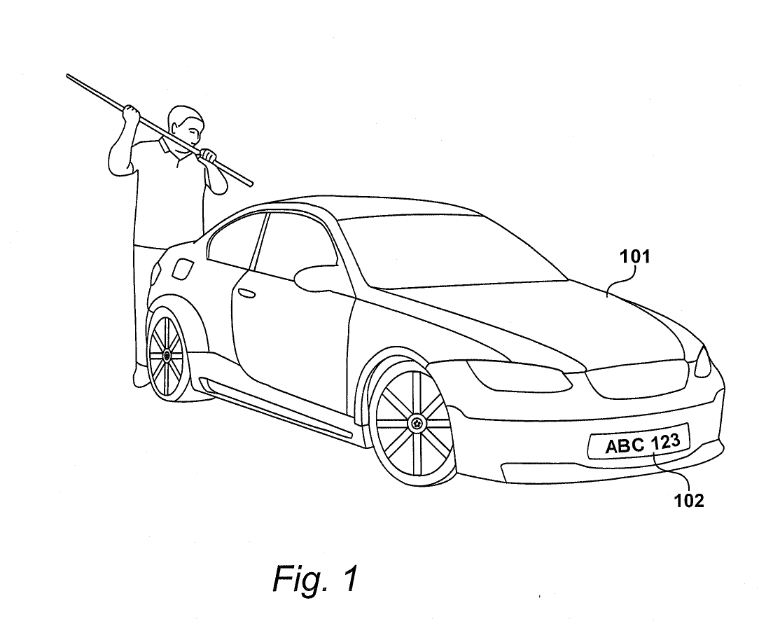

### FIG. 1

A potential theft of a motor vehicle is shown in FIG. 1. The motor vehicle is fitted with a theft detection apparatus in which an illumination device is concealed within a visible component of the motor vehicle. In particular, in this embodiment, the illumination device is concealed behind a license plate 102. A geographical detection device is concealed within the vehicle that includes a programmable component. An interface is provided for programming the programmable component with details of a geo-fence, so as to produce an alarm signal in response to detecting that the vehicle has moved outside the geo-fence. Furthermore, an energising device is provided for activating the illuminating device in response to receiving the alarm signal.

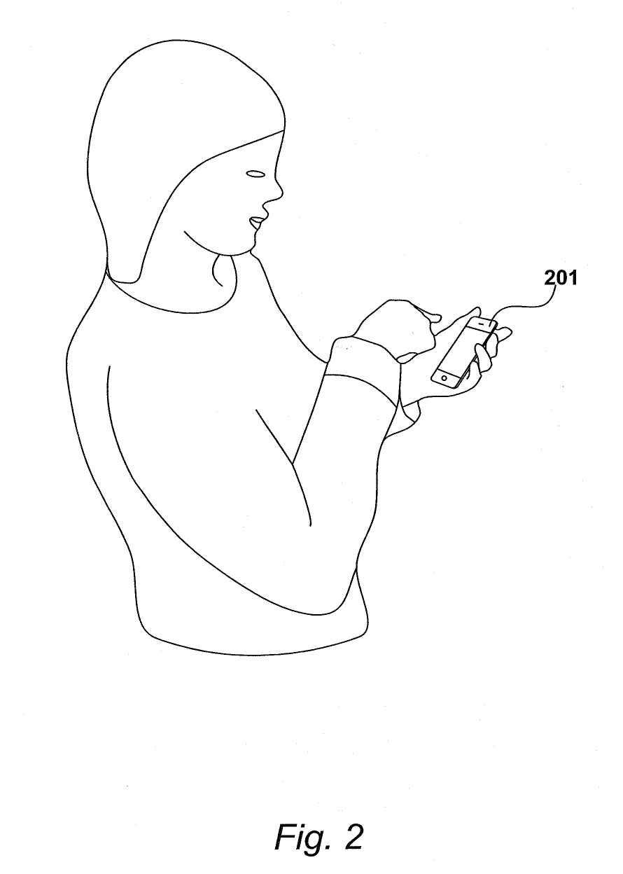

### FIG. 2

An alternative embodiment is illustrated in FIG. 2. As an alternative to providing a geographical detection device, the system relies upon manual intervention so as to cause the concealed illumination device to be activated. Thus, upon realising that motor vehicle 102 has been stolen, a driver, as shown in FIG. 2, may activate a cellular telephone 201 with a dedicated number resulting in an activation signal being conveyed to the motor vehicle 101. Thus, in response to receiving this activation signal, the illuminating device, located behind the license plate 102, is activated therefore identifying this stolen condition to other road users and law enforcement officers.

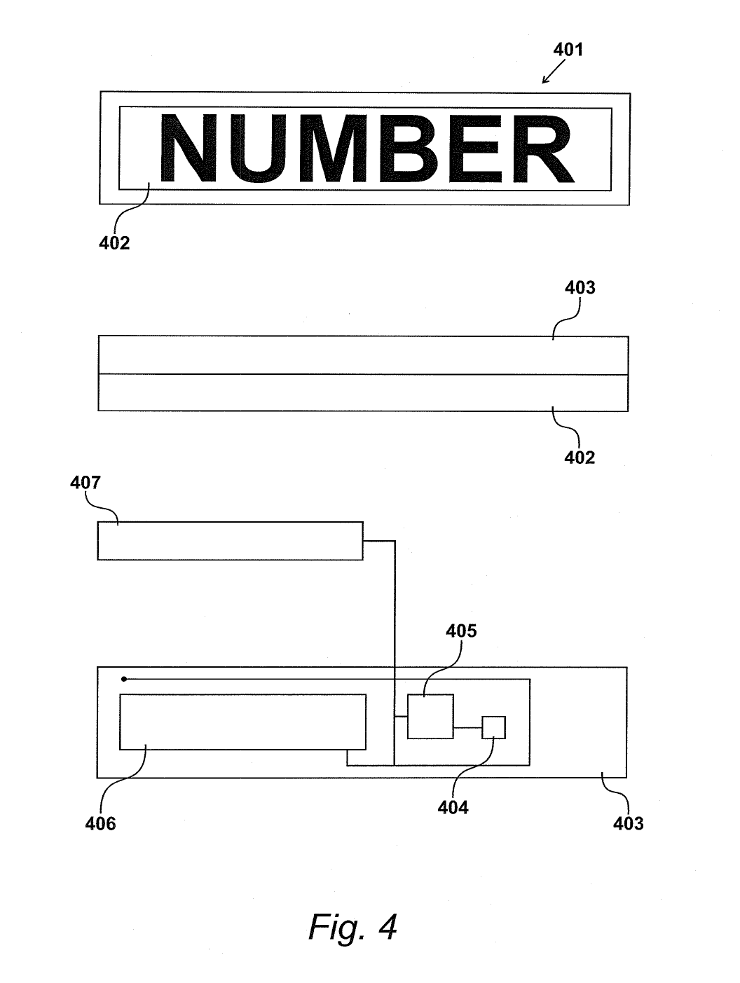

In an embodiment of the invention, a theft detection apparatus for a motor vehicle may be incorporated within the license plate itself. In this embodiment, the license plate is configured to be attached to a vehicle such that when so attached, the license plate appears substantially similar to conventional license plates. In this way, it would be difficult for a potential thief to identify the motor vehicle as including theft detection devices. In this embodiment, the license plate includes a concealed housing. Within this concealed housing there is provided a position detection device and a communication device; as detailed with reference to FIG. 4.

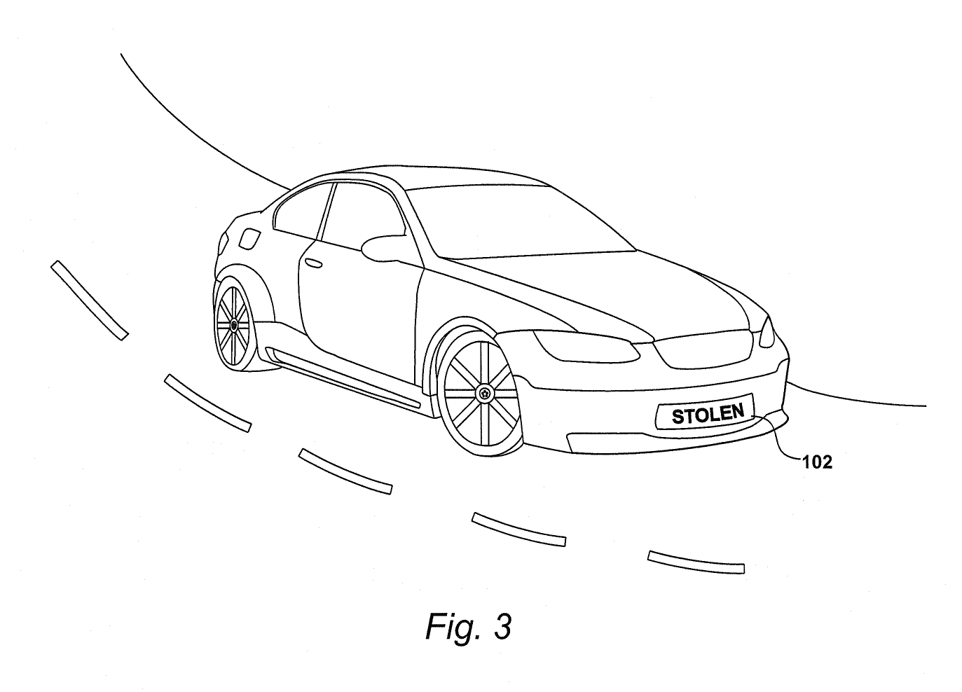

### FIG. 3

As illustrated in the example shown in FIG. 3, upon receiving an activation signal, either in response to an alarm signal being generated by the geographical device or in response to a manual activation, as illustrated in FIG. 2, the illumination device activates so that a different message is shown by the license plate 102. Thus, as shown in FIG. 3, license plate 102 now displays the message “STOLEN” or any other appropriate message type, clearly indicating that the vehicle has been stolen or has been removed without the permission of the driver, while at the same time rendering the thief oblivious to the fact that this notice is being generated. The status of the vehicle is therefore brought to the attention of the police, with minimal intervention on the part of the public.

### FIG. 4

In the embodiment shown in FIG. 4, a theft detection apparatus for a motor vehicle takes the form of a license plate 401. The license plate includes a front cover display 402 and a concealed housing 403. Within the concealed housing 403, there is provided a position detection device 404 and a communication device 405.

In the embodiment shown in FIG. 4, the detection device also includes a battery 406 concealed within the housing 403. In an embodiment, the motor vehicle includes a first battery for supplying electrical energy to electrical components within the motor vehicle. The second battery is charged by receiving electrical energy from this first battery. Alternatively, the first battery could supply electrical energy directly to the position detection device 404 and the communication device 405. In an alternative embodiment, the apparatus may include a photo-voltaic device 407 for generating electrical energy upon exposure to sunlight, wherein the second battery is charged by receiving electrical energy generated by the photo-voltaic device. In this way, the apparatus could be totally independent of the vehicle's primary battery.

In an embodiment, the position detection device 404 is a Global Positioning Satellite (GPS) SYSTEM.

In an embodiment, independent data processing equipment may be provided, possibly in the form a microcontroller. However, in a preferred embodiment, the cellular mobile telephony system 405 also includes a data storage device and a programmable processing device. Apparatus of this type is generally available, often being referred to as a cellular modem. Thus, the cellular modem is provided with sufficient data processing capability for external instructions to be downloaded for implementation in accordance with embodiments of the present invention. Thus, once instructed in this way, the device may be configured to receive input commands to activate operation of the apparatus and to specify operational characteristics. This could, for example, include receiving data defining the location of a geo-fence and also receiving an activation signal, when the vehicle is parked, followed by a deactivation signal when the authorised user wishes to use the vehicle again.

Upon detecting that the vehicle has been moved outside the geo-fence without authorisation, the cellular telephony device 405 may be configured to generate an output call to the owner and/or to the police and/or to a third party agency. Such an operation could be performed as an alternative, or as an addition, to a locally displayed message as described herein.

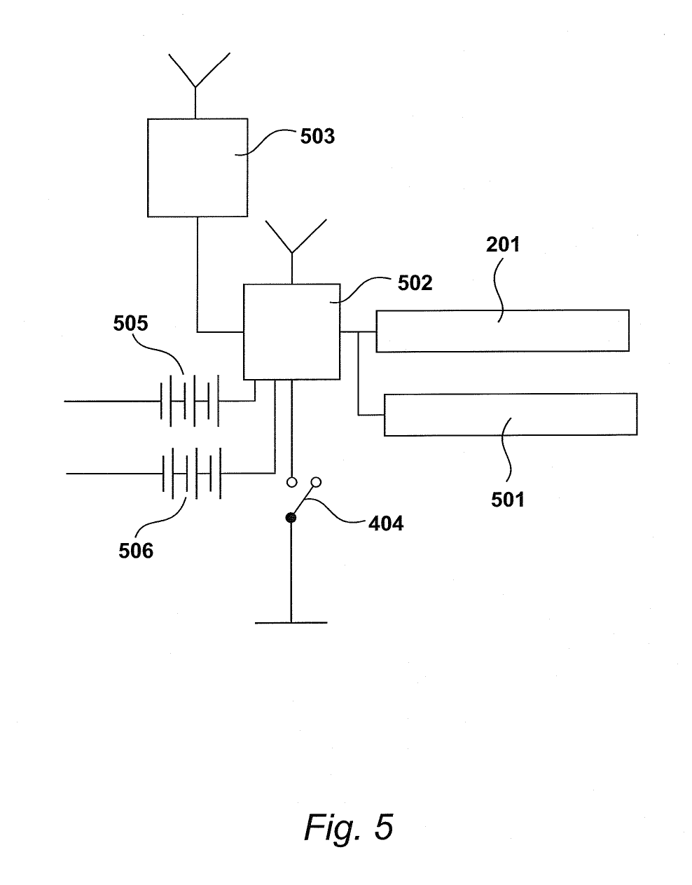

### FIG. 5

A schematic representation of the theft detection apparatus identified in FIG. 1 is detailed in FIG. 5. In this embodiment, front number plate 201 is shown along with a rear number plate 501, both of which may be illuminated by illumination device 502. Illumination device 502 includes a cellular modem configured to receive an activation signal from the aggrieved driver via their cellular telephone, as illustrated in FIG. 2. In addition, the system is provided with a global positioning satellite system (GPS) 503 programmed to define a “geo-fence”. As is known in the art, global positioning satellite systems rely upon definitions or values of longitude and latitude. Thus, it is possible to define a specific geographical region enclosed by a boundary, which has become generally known as a “geo-fence”. In this embodiment, the system is configured such that while the vehicle remains within the enclosed region, no alarm signal is generated. However, if an assessment is made to the effect that the vehicle has travelled outside the enclosed region, an alarm is generated and the license plates 201, 501 are illuminated in order to display “STOLEN” or similar.

In a further alternative embodiment, it is possible for other detection devices to be provided. Thus, for example, a switch 504 may be included, possibly responsive to an interior light being activated, similar to the situation occurring when the vehicle is broken into and a door is opened to allow a thief to gain access. Thus, in an embodiment, it is possible for an alarm to be raised by a remote operation performed by the owner, the driving of the vehicle outside of the geo-fence region, or by an internal switch 504.

In a preferred embodiment, in order for a geo-fence to be defined, it is possible for co-ordinate locations to be specified using a mobile cellular telephone application, whereafter the programming details are conveyed to the GPS device 503.

The vehicle includes a first battery, usually a 12 volt lead-acid battery, for powering electrical devices within the vehicle. Thus, in an embodiment, this first battery is used for energising the device when an alarm signal is raised. The first battery is identified in FIG. 4 at 505. In addition, in an embodiment, a second local battery 506 is provided. In an embodiment, this is a substantially thin battery contained within the enclosure of the number plate 102.

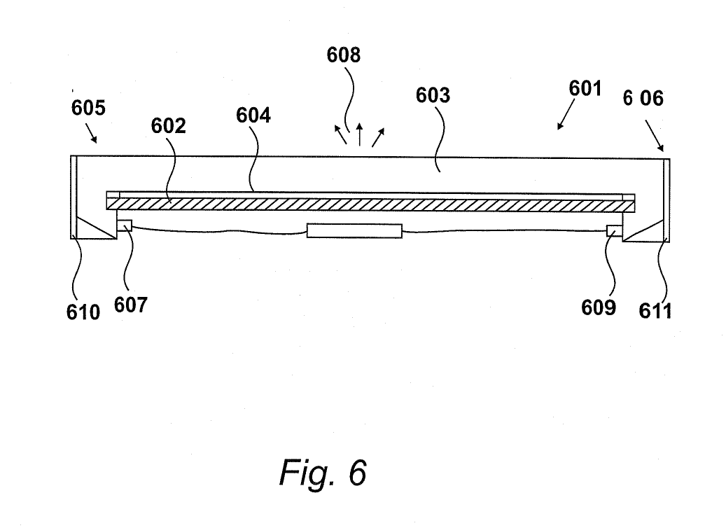

### FIG. 6

An illuminating device 601 is illustrated in FIG. 5. The illuminating device may be used for illuminating a vehicle license plate and is provided with a reflective back plate 602 that is covered in a retro-reflective material. As is known in the art, a retro-reflective material has a coated surface configured to reflect a proportion of incident light back in the direction of the light source.

However, the present applicants have identified problems due to the presence of this material when providing additional illumination to a license plate in order to modify a message displayed thereby, as previously described with reference to FIG. 3.

The illuminating device is provided with a front plate 603, moulded in a plastics material, such as acrylic. The front plate is configured to receive light, possibly from an array of light emitting diodes, in order to display an output message defined by a plurality of cavities in the front plate. However, as previously described, the presence of the retro-reflective material creates issues in terms of the desired operation of the cavities. Consequently, in order to overcome this, the illuminating device is provided with an interface 504 between the reflective back plate 602 and the front plate 603. In an embodiment, this interface is an air gap.

The configuration of the device shown in FIG. 6 may be deployed in many environments for many different purposes. However, in this embodiment, it is intended for use as a theft detection apparatus as described with respect to FIG. 3.

In an embodiment, the cover plate 603 appears substantially transparent to allow the back plate 602 to be seen when not energised and is configured to display a message when energised. The front surface 603 (shown from above in FIG. 5) is arranged to be in a viewing position. Furthermore, the front plate has a first side edge 605 and a second side edge 606. A light source 607 directs light into the material via side edge 605.

Thus, in operation, light enters the cover and is internally reflected until it encounters a cavity which then results in light being transmitted out of the cover in the direction substantially perpendicular to the front cover plate surface, as indicated by arrows 608.

The applicants have realised that the diameter and depth of the cavities is crucial in terms of providing the desired degree of transparency when not energised while at the same time providing an appropriate contrast when energised, such that the message can be seen. The applicants are aware that the crucial factor is not related to the total amount of energy light output, and is more related to the actual contrast between the two specific regions. Thus, it is undesirable for light to be allowed to escape in the regions that do not include cavities.

Small cavities improve transparency while large cavities improve light output. Consequently, a compromise is required. In an embodiment, the cavities have a depth greater than fifty micrometre and preferably smaller than two hundred micrometre. Furthermore, in an embodiment, the cavities have a diameter greater than fifty micrometre and preferably a diameter smaller than twenty micrometre. In an embodiment, a second light source 609 is provided and, in an embodiment, the light source comprises a plurality of light emitting diodes.

An embodiment of the illuminating apparatus, as shown in FIG. 6, may be used for illuminating a motor vehicle license plate. The apparatus has a base plate 602 formed from a plastics material having a front portion 606, a first side portion 605 and a second side portion 506. A first reflective edge plate 610 is attached to the first side portion 605. A second reflective edge plate 611 is attached to the second side portion 606. A first illuminating device 607 is located behind the base plate 602 so as to direct light into the first side portion 605.

In an embodiment, the illuminating apparatus also has a second illuminating device 609 located behind the base plate 502, so as to direct light into the second side portion 606.

In an embodiment, the first illuminating device is a plurality of light emitting diodes. Furthermore, in an embodiment, the illuminating apparatus may be configured to illuminate a license plate in response to receiving an alarm signal.

What we claim is:

1. A theft detection apparatus for a motor vehicle, comprising a license plate configured to be attached to a vehicle such that when so attached said license plate appears substantially similar to conventional license plates, wherein:
said license plate includes a concealed housing;
a position detection device is contained within said concealed housing; and
a communication device is contained within said concealed housing.

2. The apparatus of claim 1, wherein:
said motor vehicle includes a first battery for supplying electrical energy to electrical components within the motor vehicle; and
electrical energy for said position detection device and said communication device is received from said first battery.

3. The apparatus of claim 1, wherein said detection device includes a second battery concealed within said housing.

4. The apparatus of claim 3, wherein:
said motor vehicle includes a first battery for supplying electrical energy to electrical components within the motor vehicle; and
said second battery is charged by receiving electrical energy from said first battery.

5. The apparatus of claim 3, including a photo-voltaic device for generating electrical energy upon exposure to sunlight, wherein said second battery is charged by receiving electrical energy generated by said photo-voltaic device.

6. The apparatus of claim 1, wherein said position detection device comprises a global positioning satellite (GPS) system.

7. The apparatus of claim 1, wherein said communication device comprises a cellular mobile telephony system.

8. The apparatus of claim 7, wherein said cellular mobile telephony system also includes a data storage device and a programmable data processing device.

9. The apparatus of claim 8, wherein said cellular mobile telephony device is configured to receive input commands to activate operation and to specify operational characteristics.

10. The apparatus of claim 9, wherein said operational characteristics includes a definition for a geo-fence.

11. The apparatus of claim 8, wherein said cellular mobile telephony device is configured to generate an output call if a detection has been made to the effect that the motor vehicle has been stolen.

12. The apparatus of claim 1, wherein said license plate comprises:
a reflective back plate covered in a retro-reflective material;
a plastics material front plate for receiving light in order to display an output message defined by a plurality of cavities in said front plate; and
an interface between said reflective back plate and said front plate.

13. The apparatus of claim 12, wherein said interface is an air-gap.

14. The apparatus of claim 1, wherein said license plate comprises:
a cover that appears substantially transparent to allow a back plate to be seen when not energised and configured to display a message when energised, comprising:
a front surface arranged to be in a viewing position and side edges;
a plurality of cavities arranged in the form of said message in said front surface; and
a light source for directing light into said material via at least one of said edges.

15. The apparatus of claims 11, wherein said cavities have a depth greater that fifty micrometre and smaller than two hundred micrometre and said cavities have a diameter greater than fifty micrometre and smaller than two hundred micrometre.

16. A theft detection apparatus for a motor vehicle, comprising:
an illumination device concealed within a visible component of said motor vehicle;
a geographical detection device concealed within said vehicle, including a programmable component;
an interface for programming said programmable component with details of a geo-fence so as to produce an alarm signal in response to detecting that said vehicle has moved outside said geo-fence; and
an energising device for activating said illumination device in response to receiving said alarm signal.

17. The theft detection apparatus of claim 16, wherein said visible component is a license plate.

18. The apparatus of claim 16, wherein said interface is presented as a graphical user interface via a mobile cellular telephone. 30

19. An illuminating apparatus for a motor vehicle license plate, comprising:
a base plate;
a plastics material cover having a front portion, a first side portion and a second side portion;
a first reflective edge plate attached to said first side portion;
a second reflective edge plate attached to said second side portion; and
a first illuminating device located behind said base plate so as to direct light into said first side portion.

20. The apparatus of claim 19, further comprising a second illuminating device located behind said base plate so as to direct light into said second side portion.
